(19) United States
(12) Patent Application Publication
(10) Pub. No.: US 2026/0005498 A1
(43) Pub. Date: Jan. 1, 2026

(54) FLEXIBLE HOUSING TUBE FOR HOLDING CABLES

(71) Applicant: CHI-HUNG CHEN, Dalin Township (TW)

(72) Inventor: CHI-HUNG CHEN, Dalin Township (TW)

(21) Appl. No.: 18/757,394

(22) Filed: Jun. 27, 2024

(51) Int. Cl. H02G 3/04; F16L 11/12

(52) U.S. Cl. CPC H02G 3/0462; F16L 11/12

(57) ABSTRACT

The present utility model provides a flexible housing tube for holding cables, which is an elastically stretchable housing tube in the form of a spiral coil, having a continuous slot on the outer periphery of the housing tube, so that the cable to be stored can be put through the slot into the housing tube and be hidden inside. When the housing tube automatically shrinks to the shortest state, the cable will also shrink to the minimal length. To use the cable, just pull the cable and the housing tube will allow the cable to extend to the required length. Through the present utility model, the operation to use or store the cable is convenient and can be completed easily.

### BACKGROUND OF INVENTION

### 1. Field of the Invention

The present invention relates generally to a flexible and stretchable housing tube in the form of a spiral coil, having a continuous slot of a preset width provided on the outer periphery of the tube body, through which a cable can be put into the housing tube, so that the cable can stretch along with the housing tube, to be uncoiled for use or recoiled for storage.

### 2. Description of Related Art

At home or in business offices and factories, a variety of cables are used, for example: the power cords of electric appliances, extension cables, signal transmission wires, USB cables, earphone cords etc., which are mostly in the form of a free wire of a preset length without any storage facility. The conventional method for storing various cables is to continuously fold the cable into a bundle and then fasten the bundle with a rubber string. However, as rubber strings are subject to elastic fatigue and may deteriorate overtime, the life cycle is very short. Moreover, cables may easily get knotted. A USB cable (cable 1) is depicted in FIG. 1 to show the conventional method for storing cables. The length of the cable 1 may be 0.5m, 1.5m or 2m (other cables may be even longer). Whether in use or not in use, the cable 1 is in disorder. Particularly when it is not used, how to store it tidily is a big headache for users.

Some manufactures have developed a flexible silicone tie 3 (or an adjustable tie in the form of a Velcro tape) to replace the rubber string for storing cables 1. The tie 3 has a long life cycle and can be used to store most types of cables. However, when the cable 1 is repeatedly bent and folded, the skin of the cable or the metal cords inside can be easily damaged, causing shortened life cycle of the cable. Particularly when the cable is a power cable for a high-power electric appliance, repeated bending and folding of the cable may cause poor heat radiation of the cable, and there will be a risk that the skin of the cable may melt under high temperature to cause short circuit or even fire.

In the case of a long cable, the aforesaid method to bend and fold the cable repeatedly is time-consuming and troublesome. Although the tied-up cable is greatly shortened, it still cannot provide a tidy visual effect.

### SUMMARY OF THE INVENTION

The present utility model aims to overcome the problems of the existing method for cable storage, i.e., damage of the cable due to repeated bending and folding, poor heat radiation of the power cable for a high power electric appliance, troublesome operation to store the cable, and untidy appearance. Therefore, the present utility model provides a flexible housing tube for holding cables, which is an elastically stretchable housing tube in the form of a continuous spiral coil, having an open slot on the outer periphery, through which a cable can be put into the housing tube, so that the cable can stretch along with the housing tube, to be uncoiled for use and recoiled for tidy storage. Meanwhile, the present utility model can avoid excessive bending and folding so as to maintain the original durability of the cable.

The technical solution adopted by the present utility model to overcome the aforementioned problems includes: the present utility model provides a flexible housing tube for holding cables, which is a housing tube of a preset length formed as a continuous spiral coil so that it can stretch elastically, the outer periphery of the housing tube having a slot through which a cable can be put into the tube and be hidden inside without falling out.

The technical solution adopted by the present utility model to overcome the aforementioned problems further includes: the slot can open and close elastically, and when the external force disappears, it will return to its original width, thus the cable can be easily put in and will not fall out.

Therefore, through the slot provided on the outer periphery of the housing tube of the present utility model, the cable to be stored can be enclosed by the housing tube without falling out. Meanwhile, as the housing tube itself can shrink automatically, the cable can be tidily stored in a minimal length. To use the cable, it can be pulled to extend to the required length. Both uncoiling for use and recoiling for storage can be operated easily and conveniently.

### BRIEF DESCRIPTION OF THE DRAWINGS

FIG. 1 is a perspective view of the conventional method for cable storage.

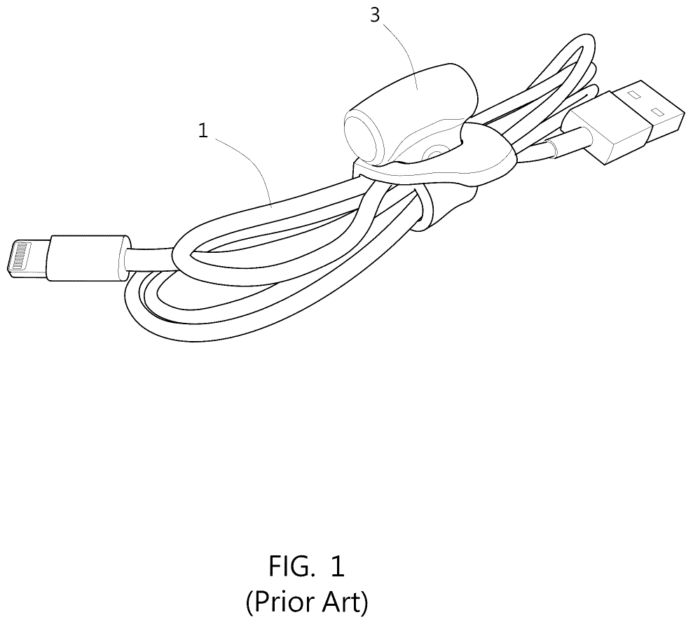

FIG. 2 is an enlarged view of the housing tube of the present utility model.

FIG. 3 is a perspective view of the housing tube of the present utility model after holding a cable.

FIG. 4 a schematic view of the present utility model after the cable is extended.

Indication of the reference numbers given in the drawings: 1-housing tube; 10-slot; 2-cable; 21-socket.

### DETAILED DESCRIPTION OF THE INVENTION

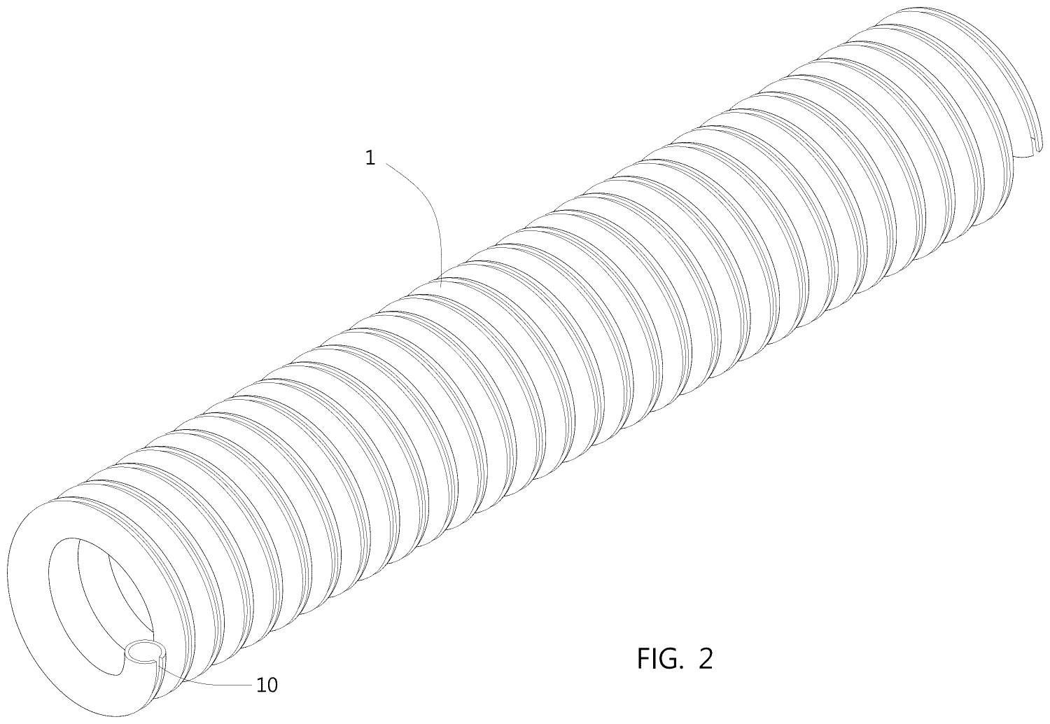

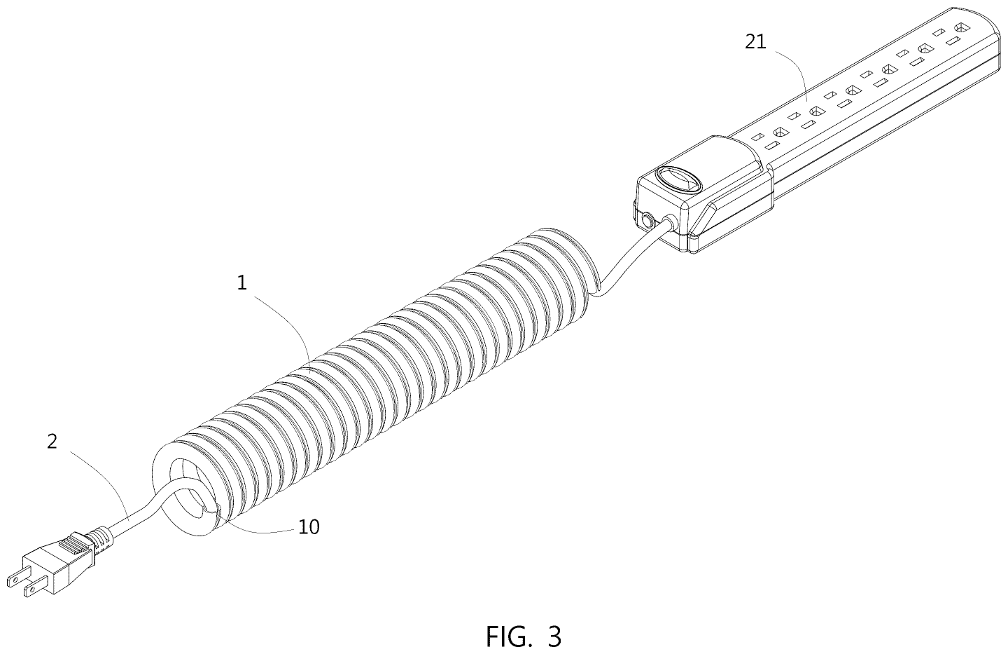

Please refer to FIG. 2. The present utility model provides a flexible housing tube for holding cables 1, which is a tube body in the form of a continuous spiral coil so that it can be stretched or shrunk elastically. The outer periphery of the housing tube 1 is provided with a continuous slot 10 of a preset width, which can open and close elastically. Using the cable 2 as an extension cord with a socket 21 shown in FIG. 3 for example, the width of the slot 10 of the housing tube 1 allows the cable 2 to be put into the housing tube 1 and prevents it from falling out, and the length of the housing tube 1 perfectly matches the length of the cable 2 for storage. The cable 2 is spirally coiled along with the housing tube 1. When the housing tube 1 automatically shrinks, the cable 2 is shrunk to the shortest length, in a tidily arranged state.

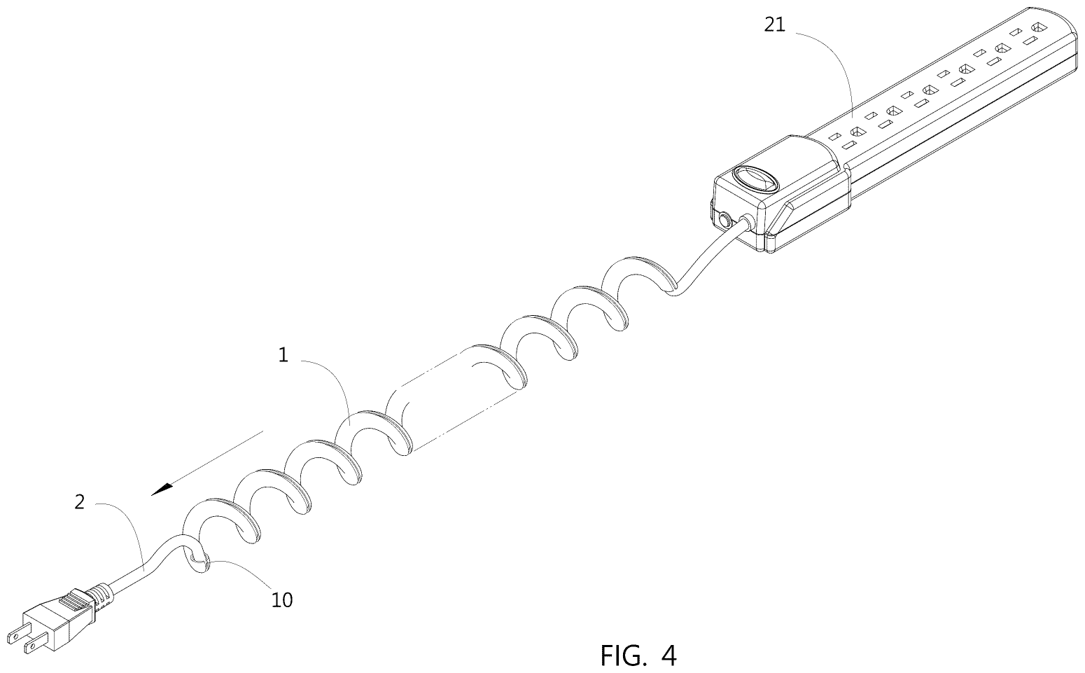

Thus, to use the cable 2, just use an external force to stretch it as shown in FIG. 4, and the cable 2 will extend to the required length for use. The operation to stretch the cable for use is simple and easy; vice versa, to store the cable after using, simply release the pulling force applied upon the cable, and the cable 2 will shrink along with the automatic shrinkage of the housing tube 1, to return to the state shown in FIG. 3. In this way, the cable 2 can be stored tidily, instead of occupying the space in a disorder.

Hence, the length, diameter, and width of the slot 10 of the automatically shrinking housing tube 1 of the present utility model can be tailored to the cable to be stored, such as a USB cable, an earphone cord, an extension cable for power supply, or the power cable of an electric appliance. Or, based on the required diameter of the tube and required width of the slot 10, a long housing tube 1 can be made, and can be cut into the required lengths according to the customization needs of users.

Specifically, the slot 10 provided on the outer periphery of the housing tube 1 can open and close elastically. When the external force disappears, the slot 10 will return to its original state in the preset width, so that the cable can be easily put into the tube and will not fall out.

1. A flexible housing tube for holding cables, characterized in that: it is a housing tube of a preset length in the form of a continuous spiral coil so that it can be stretched or shrunk elastically, and the outer periphery of the housing tube is provided with a slot of a preset width.

2. The flexible housing tube for holding cables defined in claim 1, characterized in that: the slot can open or close elastically, and when the external force disappears, it will return to the preset width.
